(19) United States
(12) Patent Application Publication
(10) Pub. No.: US 2010/0139677 A1
(43) Pub. Date: Jun. 10, 2010

(54) CONTAINER FOR NAIL POLISH

(76) Inventor: YI-LI TSAI, Taichung City (TW)

Correspondence Address: LEONG C LEI, PMB # 1008, 1867 YGNACIO VALLEY ROAD, WALNUT CREEK, CA, 94598, US

(21) Appl. No.: 12/329,643

(22) Filed: Dec. 8, 2008

(51) Int. Cl. A45D 29/11; A45D 29/00; B43K 31/00

(52) U.S. Cl. 132/74.5; 401/138; 401/172; 401/184

(57) ABSTRACT

A container for nail polish is disclosed. An appropriate amount of nail polish container in the container is delivered by pressing a control on the container. The container has an elongated body having a storage chamber containing nail polish, and the bottom of the elongated body is a pushing rod, allowing the bottom section of the container to rotate along the pushing rod. The pressing of the control element causes the gear member to rotate, which moves up the pushing rod and a valve plate on the valve seat squeeze the nail polish to the bristles provided at the valve seat.

### TECHNICAL FIELD OF THE INVENTION

The present invention relates to a container, and in particular, a container for nail polish which allows the delivery of nail polish with a control element.

### DESCRIPTION OF THE PRIOR ART

FIG. 6 is a conventional container for nail polish, which comprises a body 30 to contain nail polish, a cap 31 for capping the opening of the container body 30. The center interior of the cap 31 is a shaft 32 for brush, and the end of the shaft is positioned with bristles 33. The nail polish is withdrawn by inserting the shaft 32 into the container body 30. After use, the container body 30 is capped by the cap 31. The drawback of this container for nail polish is that the amount of nail polish cannot be controlled. It is very often that the amount of nail polish that withdrawn is more than it is needed.

Another drawback of the conventional nail polish container is that the mouth of the container is contaminated with nail polish due to excessive withdrawal of the nail polish.

Accordingly, it is an object of the present invention to provide a container for nail polish with mitigates the above drawbacks.

### SUMMARY OF THE INVENTION

Accordingly, it is an object of the present invention to provide a container for nail polish having an elongated body, for filled material, mounted with a pushing rod and gear components for controlling the pushing rod, wherein the top end of the elongated body is an outlet for the mounting of an outlet valve seat having bristles, characterized in that the middle section of the inner edge of the elongated body is provided with protruded stripes, dividing into a top and a bottom sections, the upper section is a hollow storage chamber; the protruded stripes are for the positioning of a screw mount, and the screw mount matches with the protruded stripes, a center screw hole is provided for the mounting of the pushing rod, one end of the pushing rod is disposed with a valve plate for squeezing of material contained in the interior of the elongated body, and the face of the pushing rod is provided with a positioning side, an elastic sheet is positioned between the bottom face of the screw mount and the gear members, an the gear members are positioned with positioning protruded stripes for stopping the positioning side, an elastic sheet is positioned between the bottom face of the screw mount and the gear members, and the gear members are positioned with positioning protruded stripes for stopping the positioning side such that the gear members form with the pushing rod as one body, the bottom edge of the gear member is provided with protruded gear face for engagement with the edge gear at the gear rod, the gear rod is positioned at the center of a plastic ring and a control element is directly linked to the rear end of the gear rod, the pressing of the control element controls the sliding of the gear rod, causing the gear element to rotate and control the push rod to rotate, then the valve plate rotates toward the outlet end, and liquid material is squeezed out.

Yet still another object of the present invention to provide a container for nail polish, wherein the face of the pushing rod is a positioning side mounted at one side or two sides of the elongated body.

A further object of the present invention to provide a container for nail polish, wherein the outer side of the valve seat is a cap for covering the container.

A further still object of the present invention to provide a container for nail polish, wherein the cap is provided with an elastic pad for sealing the container.

Another yet sill an object of the present invention is to provide a container for nail polish, wherein the bottom of the center of the ring is provided with positioning ribs for holding the gear rod.

Other objects, and advantages will become more apparent in view of the following detailed description in conjunction with the accompanying drawings.

### BRIEF DESCRIPTION OF THE DRAWINGS

FIG. 1 is an exploded perspective view of the container body structure in accordance with the present invention.

FIG. 2 is a sectional view of the container body structure of the present invention.

FIG. 3 illustrates schematically the material contained in the container being pushed out therefrom.

FIG. 4 is a sectional view showing the material contained in the container being pushed out therefrom.

FIG. 5 is a schematic view showing the application of the container containing nail polish in accordance with the present invention.

FIG. 6 is a perspective view of a conventional container for nail polish.

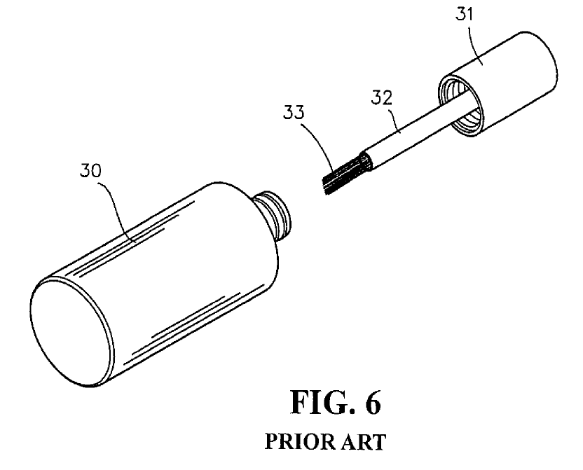

### DETAILED DESCRIPTION OF THE PREFERRED EMBODIMENTS

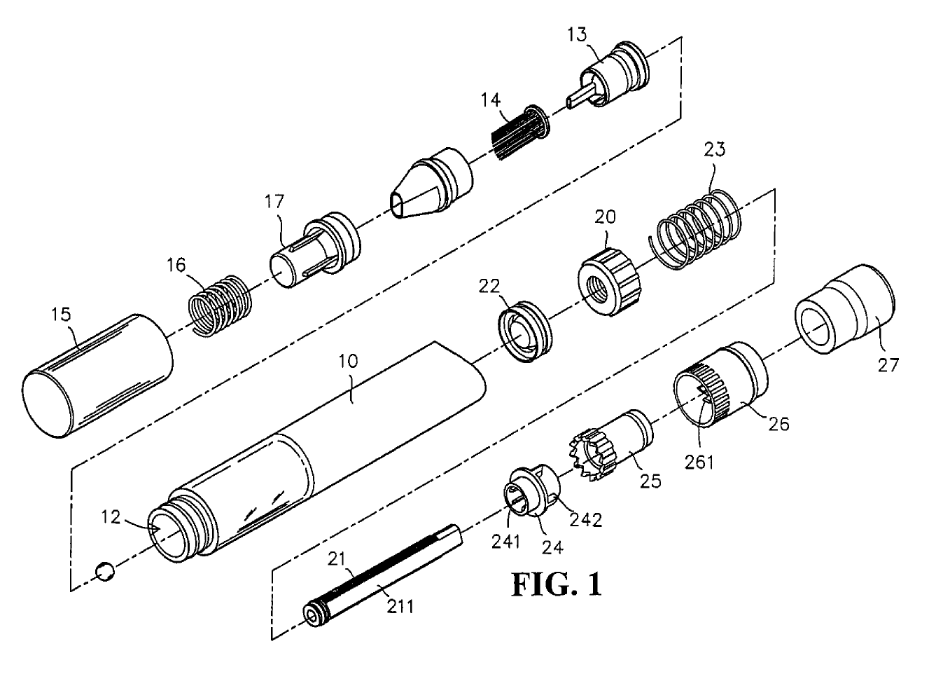

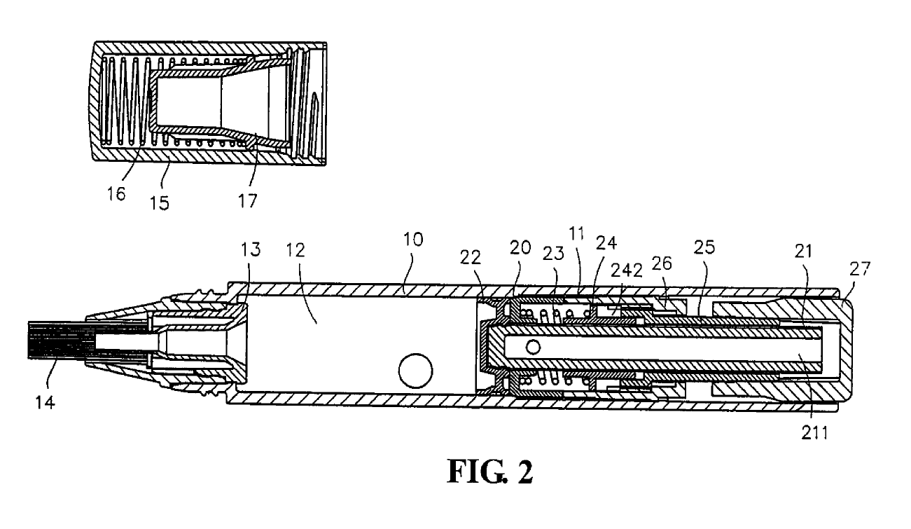

Referring to FIGS. 1 to 5, there is shown a container for nail polish having an elongated body 10. The inner edge of the hollow interior of the body 10 is provided with protruded stripe 11, and the inner edge is divided into an upper and a lower section. The upper section is a storage chamber 12 for holding cosmetics or cosmetic creams or lotions. The top end of the body is an outlet mounted with a valve seat 13 for delivery of feeds. The outlet of the seat body is provided with bristles 14 for the application of nail polish. The external end of the elongated body is a cap 15 for capping the edge of the outlet. The interior of the cap 15 is a sealing member 17 which is urged by an elastic member 16 such that the valve seat 13 and the bristles 14 can be capped by the cap 15, preventing the leakage and allowing the container to be carried around.

The lower section of the inner edge has a positioning screw mount 20 having protruded stripe 11. The center of the screw mount 20 has a screw hole for the positioning of the pushing rod 21. When the pushing rod 21 is pivotally mounted with a valve plate 22, the pushing rod 21 can be slidably control. One side or two sides of the pushing rod 21 has a positioning side 211. The protruded stripe 11 at the inner edge of the body 10 is mounted with an elastic member 23 to urge a gear component 24 such that the protruded stripe 41 urges the positioning side 211 and form as a unit with the pushing rod 21. The bottom edges of the gear component 24 are provided with gearing face 242 which is engageable with the top edge gear of the gear shaft 25. The gear shaft 25 passes through the center of a plastic ring 26, and together with the protruded rib 261 at the bottom section of the ring 26, the gear shaft 25 is slidably moved axially. The end of the body 10 is a control element 27 directly linked to the plastic gear shaft 25, the pressing of the control element 27 urges the gear shaft 25 to slide inward. The interlinking of the gear face of the top edge gear with the gear component 24, the gear component 24 moves slightly which urges the pushing rod 21 to rotate at the same direction. When the screw mount 20 and the protruded rib 11 are engaged, the pushing rod 21 rotates and protrudes to the other end. At the same time, the valve plate 22 at the top end of the rod 21 pushes toward the inner end of the storage chamber 12. This is the delivery operation of the material from the storage chamber.

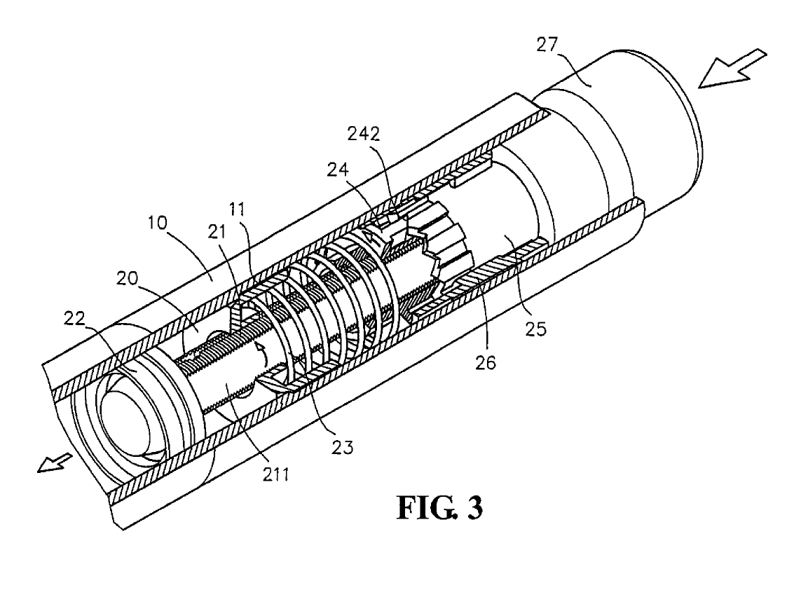

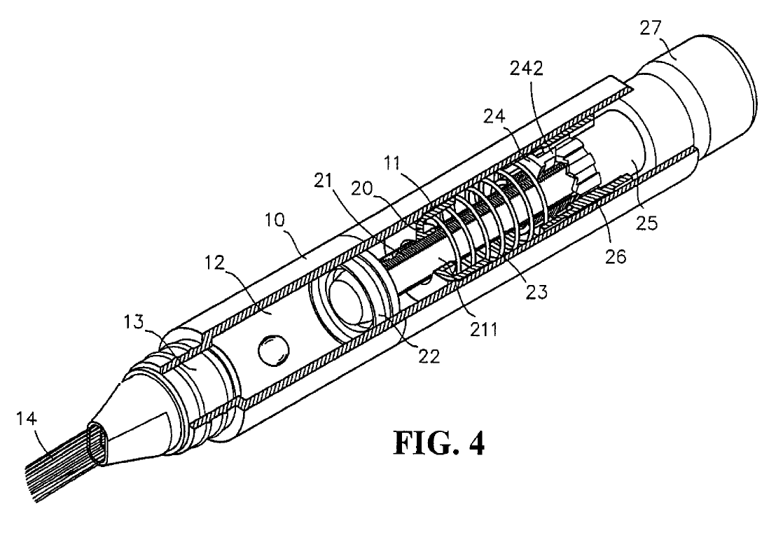

As shown in FIGS. 3 and 4, the up and down pressing of the control element 27 can control the rotation of the pushing rod 21. The engagement of the top edge gear face with the gear face of the unidirectional gear causes the pushing rod 21 to rotate and deliver material. The elastic member 23 mounted within the container restores the pushing rod 21 and other components to their original position. Thus, continuously delivery of material is achieved.

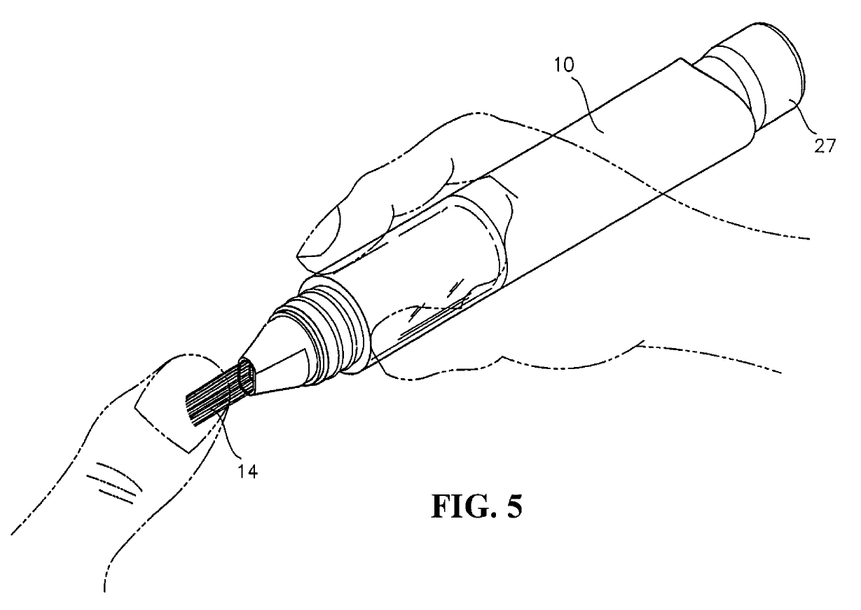

When in application, uncap the cap 15, the pressing of the control element 27 controls the pushing rod 21 to rotate and move upward and the material is squeezed to the external side of the valve seat 13 and evenly distributed onto the bristles face 14. In use of the nail polish, the body 10 is hold with the thumb and the first finger, and apply onto finger nail with the bristles 14 faces the finger nail. As shown in FIG. 5, the delivery of the material (nail polish) is control and the nail polish is evenly applied onto the finger nail. If the material is not sufficient, the depression of the control element 27 will squeeze out the material, facilitating the application of nail polish onto the finger nail.

In accordance with the present invention, the valve plate 22 at the top end of the pushing rod 21 will prevent the leakage of the material. In particular, the cap 15 is also used to seal the material from leakage from the elongated body.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A container for nail polish having an elongated body, for filled material, mounted with a pushing rod and gear components for controlling the pushing rod, wherein the top end of the elongated body is an outlet for the mounting of an outlet valve seat having bristles, characterized in that the middle section of the inner edge of the elongated body is provided with protruded stripes, dividing into a top and a bottom sections, the upper section is a hollow storage chamber; the protruded stripes are for the positioning of a screw mount, and the screw mount matches with the protruded stripes, a center screw hole is provided for the mounting of the pushing rod, one end of the pushing rod is disposed with a valve plate for squeezing of material contained in the interior of the elongated body, and the face of the pushing rod is provided with a positioning side, an elastic sheet is positioned between the bottom face of the screw mount and the gear members, an the gear members are positioned with positioning protruded stripes for stopping the positioning side, an elastic sheet is positioned between the bottom face of the screw mount and the gear members, and the gear members are positioned with positioning protruded stripes for stopping the positioning side such that the gear members form with the pushing rod as one body, the bottom edge of the gear member is provided with protruded gear face for engagement with the edge gear at the gear rod, the gear rod is positioned at the center of a plastic ring and a control element is directly linked to the rear end of the gear rod, the pressing of the control element controls the sliding of the gear rod, causing the gear element to rotate and control the push rod to rotate, then the valve plate rotates toward the outlet end, and liquid material is squeezed out.

2. The container of claim 1, wherein the face of the pushing rod is a positioning side mounted at one side or two sides of the elongated body.

3. The container of claim 1, wherein the outer side of the valve seat is a cap for covering the container.

4. The container of claim 3, wherein the cap is provided with an elastic pad for sealing the container.

5. The container of claim 1, wherein the bottom of the center of the ring is provided with positioning ribs for holding the gear rod.
